(19) United States
(12) Patent Application Publication
(10) Pub. No.: US 2022/0200524 A1
(43) Pub. Date: Jun. 23, 2022

(54) PORTABLE SOLAR PANEL SYSTEM

(71) Applicant: Goal Zero LLC, Bluffdale, UT (US)

(72) Inventor: Norman L. Krantz, Draper, UT (US)

(73) Assignee: Goal Zero LLC, Bluffdale, UT (US)

(21) Appl. No.: 17/543,507

(22) Filed: Dec. 6, 2021

Related U.S. Application Data
(60) Provisional application No. 63/127,492, filed on Dec. 18, 2020.

(51) Int. Cl. H02S 30/20; H02S 10/40; H02S 20/30; H02S 40/36

(52) U.S. Cl. CPC H02S 30/20; H02S 10/40; H01M 10/465; H02S 40/36; H02S 20/30

(57) ABSTRACT

A portable solar panel system includes a first subassembly, a second subassembly, and a support assembly. The first subassembly includes a first solar panel and a first frame extending around a first periphery of the first solar panel. The second subassembly includes a second solar panel and a second frame extending around a second periphery of the second solar panel. The first frame and the second frame are pivotably coupled together such that the first subassembly and the second subassembly are selectively foldable. The support assembly includes a first leg assembly coupled to the first frame, a second leg assembly coupled to the second frame, and a support foot pivotably coupling the first leg assembly to the second leg assembly.

### CROSS-REFERENCE TO RELATED PATENT APPLICATION

This application claims the benefit of and priority to U.S. Provisional Patent Application No. 63/127,492, filed Dec. 18, 2020, which is incorporated herein by reference in its entirety.

### BACKGROUND

A solar panel is a packaged assembly of photovoltaic cells. Solar panels use light energy (e.g., photons) from the sun to generate an electric current via the photovoltaic effect. A solar panel is typically used to generate and supply electricity to a load device or system. Solar panels are an environmentally-friendly alternative to other sources of energy such as coal, oil, or gasoline. Portable solar panels may be used in place of traditional portable power supply devices (e.g., generators, batteries, etc.).

### SUMMARY

One embodiment relates to a portable solar panel system. The portable solar panel system includes a first subassembly, a second subassembly, and a support assembly. The first subassembly includes a first solar panel and a first frame extending around a first periphery of the first solar panel. The second subassembly includes a second solar panel and a second frame extending around a second periphery of the second solar panel. The first frame and the second frame are pivotably coupled together such that the first subassembly and the second subassembly are selectively foldable. The support assembly includes a first leg assembly coupled to the first frame, a second leg assembly coupled to the second frame, and a support foot pivotably coupling the first leg assembly to the second leg assembly.

Another embodiment relates to a portable solar panel system. The portable solar panel system includes a first frame, a first solar panel supported by the first frame, a second frame, a second solar panel supported by the second frame; a hinge pivotably coupling the first frame and the second frame such that the first solar panel and the second solar panel are selectively foldable, and a support leg coupled to the first frame and the second frame. The support leg is configured to automatically deploy and prop the portable solar panel system upright when the first solar panel and the second solar panel are opened from a folded arrangement to an unfolded arrangement.

Still another embodiment relates to a portable solar panel system. The portable solar panel system includes a first solar panel assembly, a second solar panel assembly, and a first hinge positioned to hingedly couple the first solar panel assembly to the second solar panel assembly to facilitate folding the first solar panel assembly and the second solar panel assembly. Each of the first solar panel assembly and the second solar panel assembly includes a first solar panel, a first frame (a) extending around a first periphery of the first solar panel and (b) including a first upper portion, a first lower portion, a first inner portion, and a first outer portion, a second solar panel, a second frame (a) extending around a second periphery of the second solar panel and (b) including a second upper portion, a second lower portion, a second inner portion, and a second outer portion, a second hinge positioned along the first inner portion of the first frame and the second inner portion of the second frame to hingedly couple the first frame to the second frame, a handle coupled to the first outer portion of the first frame, a first bracket coupled to the first upper portion of the first frame, a second bracket coupled to the first inner portion of the first frame, a third bracket coupled to the second upper portion of the second frame, a fourth bracket coupled to the second inner portion of the second frame, a first rod extending between the first bracket and the second bracket, a second rod extending between the third bracket and the fourth bracket, a first leg pivotably coupled to the first rod proximate the first bracket, a second leg (a) pivotably coupled to the first rod proximate the second bracket and (b) coupled to the first leg at a first junction, a third leg pivotably coupled to the second rod proximate the third bracket, a fourth leg (a) pivotably coupled to the second rod proximate the fourth bracket and (b) coupled to the third leg at a second junction, and a support foot pivotably and releasably coupling the first junction to the second junction. The support foot includes a first foot portion coupled to the first junction and a second foot portion coupled to the second junction. The first hinge is positioned along the second outer portion of the second frame.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a front perspective view of a solar panel system in an operational arrangement, according to an exemplary embodiment.

FIG. 2 is a front view of the solar panel system of FIG. 1, according to an exemplary embodiment.

FIG. 3 is top view of the solar panel system of FIG. 1, according to an exemplary embodiment.

FIG. 4 is a side view of the solar panel system of FIG. 1, according to an exemplary embodiment.

FIG. 5 is a rear perspective view of the solar panel system of FIG. 1, according to an exemplary embodiment.

FIG. 6 is a rear detailed view of a portion of the solar panel system of FIG. 1, according to an exemplary embodiment.

FIGS. 7-9 show various views of the solar panel system of FIG. 1 transitioning from a folded arrangement to the operational arrangement, according to another exemplary embodiment.

FIGS. 10-13 show various views of a process of separating a support assembly of the solar panel system of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a solar panel system of the present disclosure includes solar panels that are pivotably coupled in pairs. Each of the pairs includes a support assembly coupled thereto that automatically unfolds or extends to facilitate propping the solar panel system upright when the pairs are unfolded. In some embodiments, the support assembly is selectively separable into two separate pieces to facilitate laying the solar panel system flat on a surface.

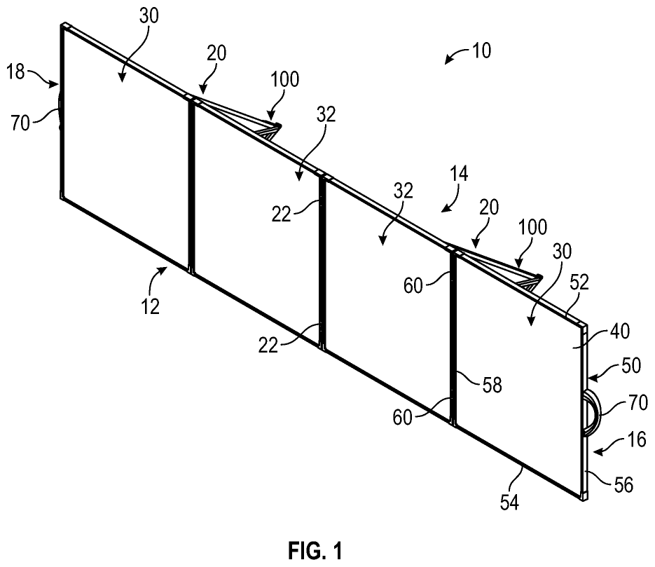

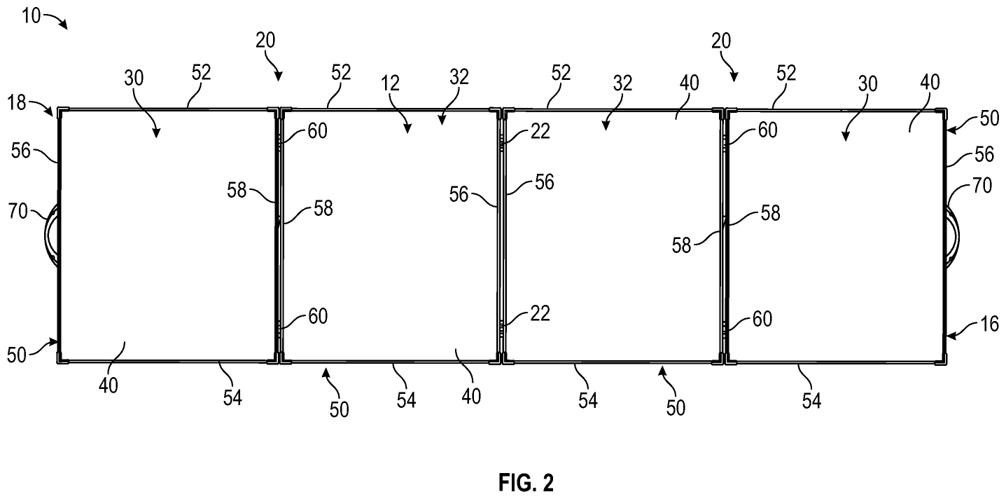

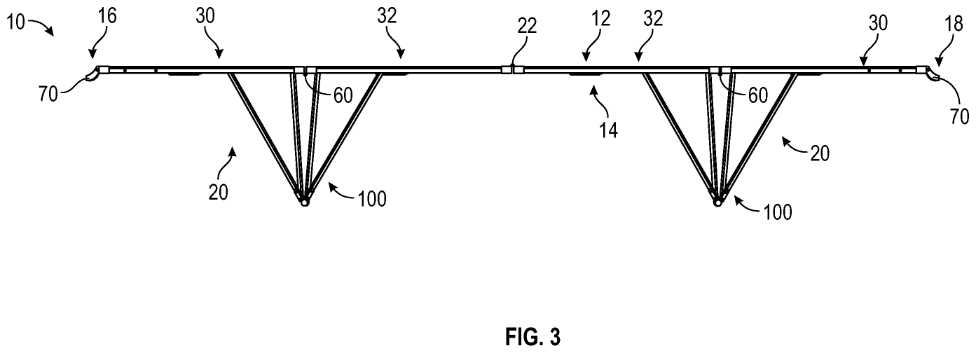

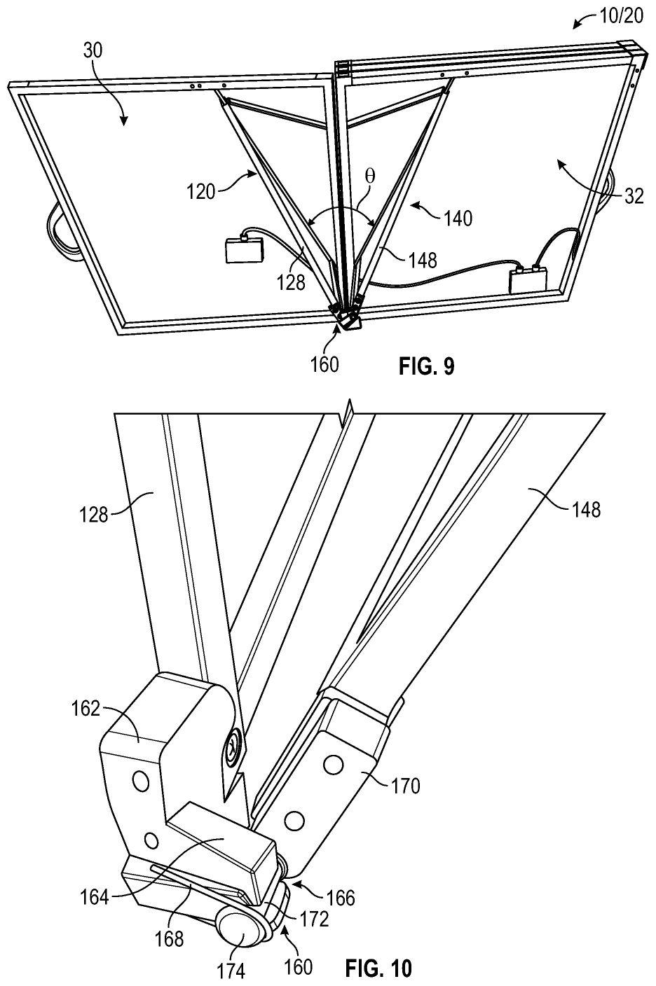

According to the exemplary embodiment shown in FIGS. 1-13, a portable solar panel system, shown as solar panel system 10, is configured to generate electrical power from incident light. The generated electrical power may be provided to charge and/and power a load device (e.g., a phone, a tablet, a computer, a portable and rechargeable battery pack, an appliance, etc.). The power output of the solar panel system 10 may be related to a surface area thereof and/or a relative orientation between the solar panel system 10 and a light source (e.g., the sun, etc.). According to an exemplary embodiment, the solar panel system 10 is lightweight and portable (e.g., the solar panel system 10 can be carried with relative ease by an average adult, less than 40 or 50 pounds, etc.).

As shown in FIGS. 1-6, the solar panel system 10 includes a first side, shown as front side 12, an opposing second side, shown as rear side 14, a first end, shown as right end 16, and an opposing second end, shown as left end 18. The solar panel system 10 includes a plurality of solar panel assemblies, shown as solar panel assemblies 20. According to the exemplary embodiment shown in FIGS. 1-3 and 5, the solar panel system 10 includes two solar panel assemblies 20. In such an embodiment, the solar panel system 10 may have the following specifications: weight—approximately 39 lbs; folded dimensions—approximately 30.6 in×26.3 in×3.8 in; unfolded dimensions (without the support leg assembly)—approximately 77.7 in×269.0 in×2.3 cm; rated power—at least approximately 300 W; open circuit voltage—approximately 23V; maximum power point voltage—approximately 19.3V. In other embodiments, the solar panel system 10 includes a single solar panel assembly 20 or three or more solar panel assemblies 20 and may have different specifications than those outlined above. As shown in FIGS. 1-3, the solar panel system 10 includes one or more first pivotal couplers, shown as main hinges 22, positioned to pivotably couple the solar panel assemblies 20 to each other to facilitate folding the solar panel system 10, which is described in greater detail herein.

As shown in FIGS. 1-6, each of the solar panel assemblies 20 includes a first subassembly, shown as outer solar panel subassembly 30; a second subassembly, shown as inner solar panel subassembly 32; one or more second pivotal couplers, shown as subassembly hinges 60, positioned to pivotably couple the outer solar panel subassembly 30 and the inner solar panel subassembly 32 to each other to facilitate folding the solar panel assemblies 20; and a support assembly, shown as support leg assembly 100, coupled to and extending from the rear side 14 thereof.

As shown in FIGS. 1, 2, 4, and 6, each of the outer solar panel subassemblies 30 and the inner solar panel subassemblies 32 of each solar panel assembly 20 includes a panel, shown as solar panel 40, and a frame, shown as solar panel frame 50, extending around the periphery of the solar panel 40. According to an exemplary embodiment, the solar panels 40 include a plurality of solar cells configured to receive and convert solar power (e.g., light energy, etc.) from a light source (e.g., the sun, etc.) to generate electrical power.

As shown in FIGS. 1, 2, 4, and 6, the solar panel frame 50 of each solar panel 40 includes a first frame member, shown as upper frame rail 52, a second frame member, shown as lower frame rail 54, a third frame member, shown as outer frame rail 56, and a fourth frame member, shown as inner frame rail 58. The upper frame rails 52 of the outer solar panel subassemblies 30 and the inner solar panel subassemblies 32 extend along the upper edges of the solar panels 40. The lower frame rails 54 of the outer solar panel subassemblies 30 and the inner solar panel subassemblies 32 extend along the lower edges of the solar panels 40.

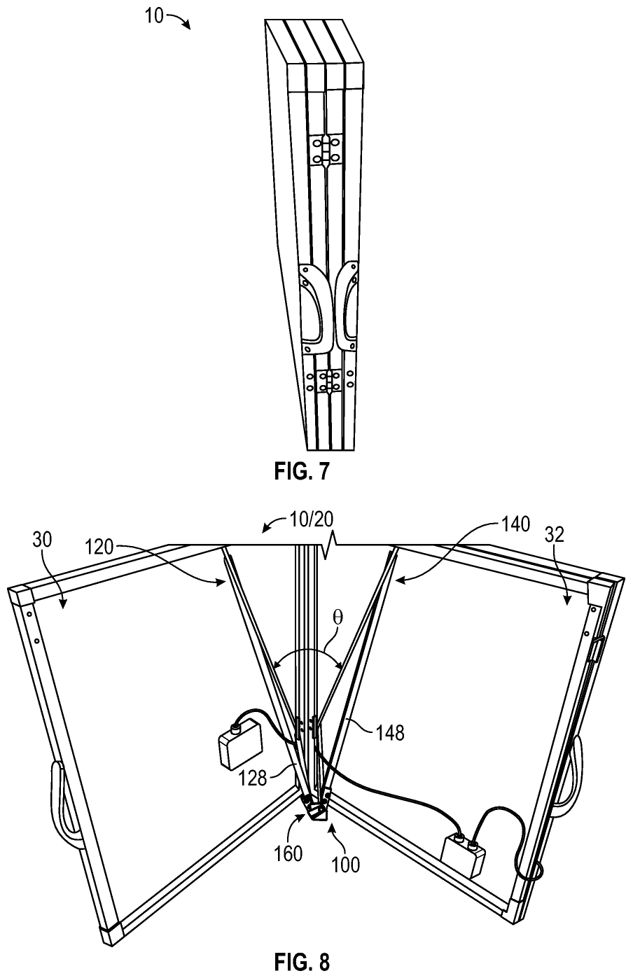

The outer frame rails 56 of the outer solar panel subassembly 30 and the inner solar panel subassembly 32 of each respective solar panel assembly 20 are positioned at opposite ends thereof. Therefore, one of the outer frame rails 56 of a respective solar panel assembly 20 is positioned at either the right end 16 or the left end 18 of the solar panel system 10 and the other one of the outer frame rails 56 of the respective solar panel assembly 20 is positioned adjacent an outer frame rail 56 of the other solar panel assembly 20. The main hinges 22 are positioned along the adjacent outer frame rails 56 of the solar panel assemblies 20 to pivotably couple the solar panel assemblies 20 together. The inner frame rails 58 of the outer solar panel subassembly 30 and the inner solar panel subassembly 32 of each respective solar panel assembly 20 are positioned adjacent each other. The subassembly hinges 60 are positioned along the adjacent inner frame rails 58 of each respective solar panel assembly 20 to pivotably couple the outer solar panel subassembly 30 and the inner solar panel subassembly 32 thereof together. According to an exemplary embodiment, the main hinges 22 and the subassembly hinges 60 facilitate selectively transitioning the solar panel system 10 between an unfolded or operational arrangement, as shown in FIGS. 1-6, and a folded or stowed arrangement, as shown in FIG. 7 (such that the solar panel system 10 is in a “briefcase” configuration).

As shown in FIGS. 1-4, the solar panel system 10 includes a pair of handles, shown as handles 70. One of the handles 70 is positioned along the outer frame rail 56 of each of the outer solar panel subassemblies 30 at the right end 16 and the left end 18 of the solar panel system 10. According to an exemplary embodiment, the handles 70 facilitate easily carrying the solar panel system 10 when the solar panel system 10 is in the folded or stowed arrangement (e.g., like a briefcase).

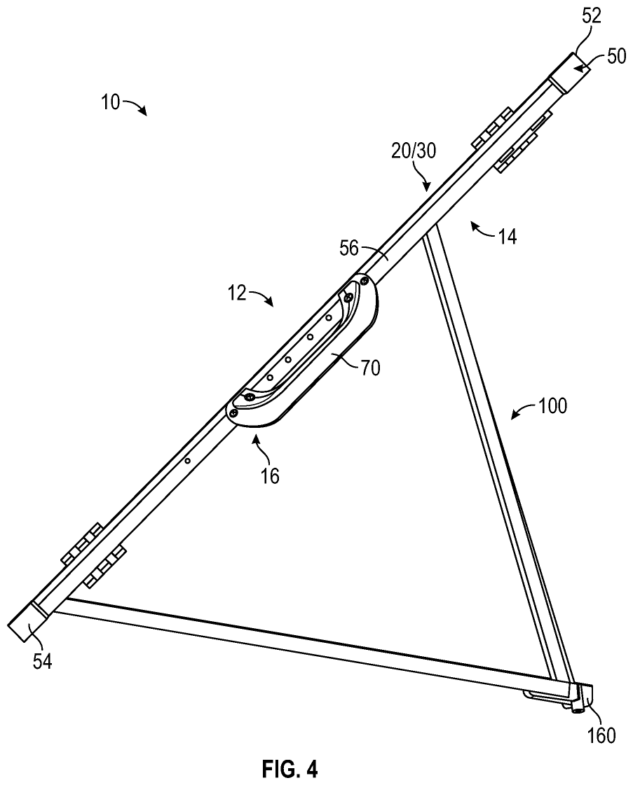

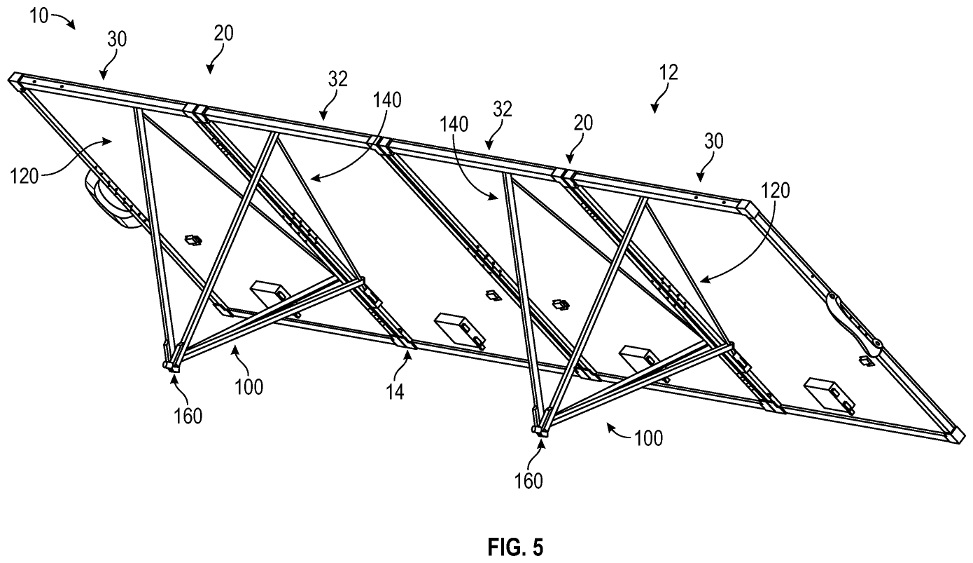

As shown in FIGS. 4-6, the support leg assembly 100 includes a first leg assembly, shown as outer leg assembly 120, a second leg assembly, shown as inner leg assembly 140, and a coupler, shown as support foot 160, pivotably coupling the outer leg assembly 120 and the inner leg assembly 140 together. As shown in FIGS. 4 and 5, the lower frame rails 54 and the support feet 160 support the solar panel system 10 and hold the solar panel system 10 in the unfolded or operational arrangement. When in the unfolded or operational arrangement, the support leg assembly 100 supports or orients the solar panel assembly at an angled orientation (e.g., 30, 45, 60, etc. degrees). In some embodiments, the angle of the solar panel system 10 when in the unfolded or operational arrangement is fixed (i.e., the support leg assembly 100 is non-adjustable). In other embodiments, the angle of the solar panel system 10 when in the unfolded or operational arrangement is adjustable (i.e., the support leg assembly 100 is adjustable).

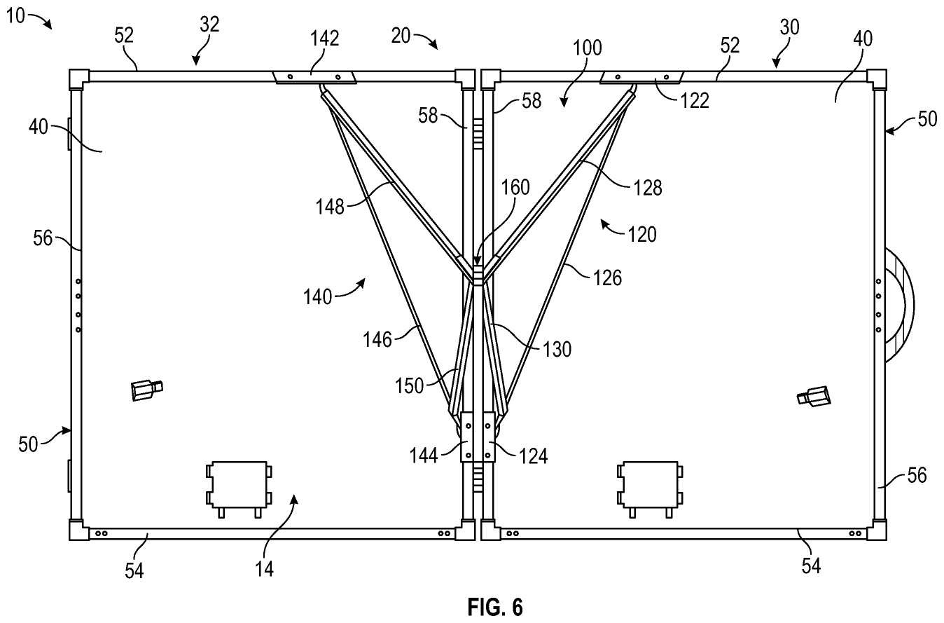

As shown in FIG. 6, the outer leg assembly 120 includes a first bracket, shown as upper bracket 122, coupled to the upper frame rail 52 of the solar panel frame 50 of the outer solar panel subassembly 30; a second bracket, shown as inner bracket 124, coupled to the inner frame rail 58 of the solar panel frame 50 of the outer solar panel subassembly 30; a first leg member, shown as rod 126, extending between the upper bracket 122 and the inner bracket 124; a second leg member, shown as upper leg 128, having (i) a first end pivotably coupled to an upper end of the rod 126 proximate the upper bracket 122 and (ii) an opposing second end; and a third leg member, shown as lower leg 130, having (i) a first end pivotably coupled to a lower end of the rod 126 proximate the inner bracket 124 and (ii) an opposing second end coupled to the opposing second end of the upper leg 128 (i.e., at a junction of the upper leg 128 and the lower leg 130). In some embodiments, the upper leg 128 and the lower leg 130 are separate components that are coupled together (e.g., with fasteners, rivets, bolts, etc.) to provide a two-piece structure. In other embodiments, the upper leg 128 and the lower leg 130 have one-piece or unitary structure (e.g., welded, unitarily formed or manufactured, a single outer leg, etc.).

As shown in FIG. 6, the inner leg assembly 140 includes a first bracket, shown as upper bracket 142, coupled to the upper frame rail 52 of the solar panel frame 50 of the inner solar panel subassembly 32; a second bracket, shown as inner bracket 144, coupled to the inner frame rail 58 of the solar panel frame 50 of the inner solar panel subassembly 32; a first leg member, shown as rod 146, extending between the upper bracket 142 and the inner bracket 144; a second leg member, shown as upper leg 148, having (i) a first end pivotably coupled to an upper end of the rod 146 proximate the upper bracket 142 and (ii) an opposing second end; and a third leg member, shown as lower leg 150, having (i) a first end pivotably coupled to a lower end of the rod 146 proximate the inner bracket 144 and (ii) an opposing second end coupled to the opposing second end of the upper leg 148 (i.e., at a junction of the upper leg 148 and the lower leg 150). In some embodiments, the upper leg 148 and the lower leg 150 are separate components that are coupled together (e.g., with fasteners, rivets, bolts, etc.) to provide a two-piece structure. In other embodiments, the upper leg 148 and the lower leg 150 have one-piece or unitary structure (e.g., welded, unitarily formed or manufactured, a single inner leg, etc.).

As shown in FIGS. 5,6, and 8-10, the support foot 160 couples (i) the junction of the upper leg 128 and the lower leg 130 of the outer leg assembly 120 to (ii) the junction of the upper leg 148 and the lower leg 150 of the inner leg assembly 140. As shown in FIGS. 7-9, the support foot 160 pivotably couples the outer leg assembly 120 to the inner leg assembly 140 such that as the outer solar panel subassembly 30 and the inner solar panel subassembly 32 of a respective solar panel assembly 20 is opened or unfolded from the folded or stowed arrangement to the unfolded or operational arrangement, the support leg assembly 100 automatically deploys (e.g., actuates, opens up, unfolds, pops out, extends, etc.). Further, an angle θ between the upper leg 128 of the outer leg assembly 120 and the upper leg 148 of the inner leg assembly 140 increases as the outer solar panel subassembly 30 and the inner solar panel subassembly 32 of the respective solar panel assembly 20 is opened or unfolded from the folded or stowed arrangement to the unfolded or operational arrangement.

As shown in FIGS. 10-13, the support foot 160 has a two-part structure including (i) a first foot component, shown as outer foot portion 162, coupled to the junction of the upper leg 128 and the lower leg 130 of the outer leg assembly 120 and (ii) a second foot component, shown as inner foot portion 170, coupled to the junction of the upper leg 148 and the lower leg 150 of the inner leg assembly 140. The two-part structure of the support foot 160 facilitates selectively decoupling and separating the outer leg assembly 120 from the inner leg assembly 140. In other embodiments, the support foot 160 has a unitary or one piece structure such that the outer leg assembly 120 and the inner leg assembly 140 are not separable.

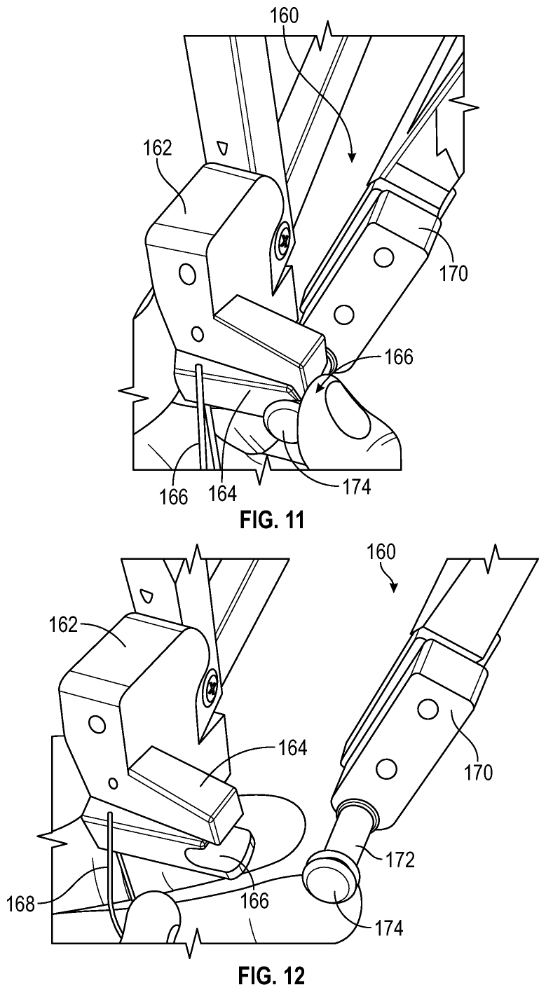

As shown in FIGS. 10-12, the outer foot portion 162 of the support foot 160 includes (i) a projection, shown as receiver 164, that defines an interface or recess, shown as slot 166, and (ii) a securing or retaining element (e.g., a retainer, a clasp, a hook, etc.), shown as latch 168, pivotably coupled thereto. The latch 168 is selectively repositionable between a closed position (see FIG. 10) and an open position (see FIGS. 11 and 12). In some embodiments, the latch 168 is pivotably biased toward the closed position (e.g., via a torsional spring, etc.). As shown in FIGS. 10-12, the inner foot portion 170 includes a protrusion, shown as latch pin 172, extending therefrom with an end thereof terminating with a knob, shown as knob 174. The latch pin 172 is selectively received by the slot 166 to pivotably couple the outer foot portion 162 to the inner foot portion 170 and, thereby, pivotably couple the outer leg assembly 120 to the inner leg assembly 140. As shown in FIG. 10, the latch 168 extends around the knob 174 of the latch pin 172 when the latch pin 172 is positioned in the slot 166 to selectively secure the latch pin 172 within the slot 166. While the receiver 164 and the latch 168 are shown as being part of the outer foot portion 162 and the latch pin 172 is shown as being part of the inner foot portion 170, in other embodiments, the receiver 164 and the latch 168 are part of the inner foot portion 170 and the latch pin 172 is part of the outer foot portion 162.

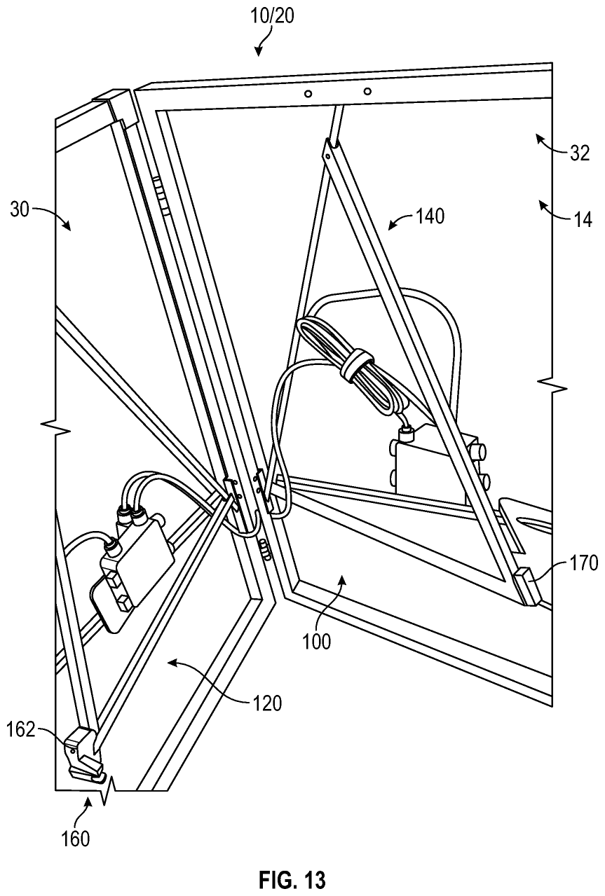

As shown in FIG. 13, the outer leg assembly 120 and the inner leg assembly 140 can be stowed flat and flush with the rear side 14 of the outer solar panel subassembly 30 and the inner solar panel subassembly 32, respectively, when decoupled from each other. The ability to separate the support leg assembly 100 facilitates laying the solar panel system 10 down flat along a surface (e.g., an angle surface, etc.). In some embodiments, the outer leg assembly 120 and the inner leg assembly 140 can be selectively secured to the rear side 14 of the outer solar panel subassembly 30 and the inner solar panel subassembly 32, respectively, with a securing element or coupler (e.g., a magnetic coupling, with a latch, with a hook, with a strap, etc.) to prevent inadvertent pivoting of the outer leg assembly 120 and the inner leg assembly 140 when decoupled.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

It is important to note that the construction and arrangement of the solar panel system 10, the solar panel assemblies 20, and the components thereof (e.g., the outer solar panel subassembly 30, the inner solar panel subassembly 32, the support leg assembly 100, etc.) as shown in the various exemplary embodiments is illustrative only. Additionally, any element disclosed in one embodiment may be incorporated or utilized with any other embodiment disclosed herein.

1. A portable solar panel system comprising:
a first subassembly including:
a first solar panel; and
a first frame extending around a first periphery of the first solar panel;
a second subassembly including:
a second solar panel; and
a second frame extending around a second periphery of the second solar panel, wherein the first frame and the second frame are pivotably coupled together such that the first subassembly and the second subassembly are selectively foldable; and
a support assembly including:
a first leg assembly coupled to the first frame;
a second leg assembly coupled to the second frame; and
a support foot pivotably coupling the first leg assembly to the second leg assembly.

2. The portable solar panel system of claim 1, further comprising a first assembly and a second assembly pivotably coupled to the first assembly such that the first assembly and the second assembly are selectively foldable, wherein each of the first assembly and the second assembly include the first subassembly and the second subassembly.

3. The portable solar panel system of claim 2, wherein the portable solar panel system weighs less than 40 pounds and has a rated power of at least approximately 300 watts.

4. The portable solar panel system of claim 2, wherein at least one of the first assembly includes a first handle or the second assembly includes a second handle that facilitate carrying the portable solar panel system like a briefcase when folded.

5. The portable solar panel system of claim 4, wherein the first assembly includes the first handle and the second assembly includes the second handle.

6. The portable solar panel system of claim 1, wherein the first leg assembly includes:
a first upper bracket coupled to a first upper frame rail of the first frame;
a first inner bracket coupled to a first inner frame rail of the first frame;
a first rod extending between the first upper bracket and the first inner bracket;
a first leg pivotably coupled to the first rod proximate the first upper bracket; and
a second leg (a) pivotably coupled to the first rod proximate the first inner bracket and (b) coupled to the first leg at a first junction.

7. The portable solar panel system of claim 6, wherein the second leg assembly includes:
a second upper bracket coupled to a second upper frame rail of the second frame;
a second inner bracket coupled to a second inner frame rail of the second frame;
a second rod extending between the second upper bracket and the second inner bracket;
a third leg pivotably coupled to the second rod proximate the second upper bracket; and
a fourth leg (a) pivotably coupled to the second rod proximate the second inner bracket and (b) coupled to the third leg at a second junction.

8. The portable solar panel system of claim 7, wherein the support foot is coupled to the first junction and the second junction.

9. The portable solar panel system of claim 7, further comprising a hinge coupled to the first inner frame rail and the second inner frame rail to pivotably couple the first subassembly to the second subassembly.

10. The portable solar panel system of claim 1, wherein an angle between the first leg assembly and the second leg assembly changes as the first subassembly and the second subassembly are folded and unfolded.

11. The portable solar panel system of claim 1, wherein the support foot includes a first foot portion coupled to the first leg assembly and a second foot portion coupled to the second leg assembly, and wherein the first foot portion and the second foot portion are selectively separable to facilitate decoupling the first leg assembly and the second leg assembly from each other.

12. The portable solar panel system of claim 11, wherein the first foot portion defines an interface and the second foot portion defines a protrusion that is selectively received by the interface.

13. The portable solar panel system of claim 12, wherein the first foot portion includes a retainer positioned to selectively engage with the protrusion to secure the protrusion within the interface.

14. The portable solar panel system of claim 13, wherein the retainer is biased into a securing position to hold the protrusion within the interface.

15. A portable solar panel system comprising:
a first frame;
a first solar panel supported by the first frame;
a second frame;
a second solar panel supported by the second frame;
a hinge pivotably coupling the first frame and the second frame such that the first solar panel and the second solar panel are selectively foldable; and
a support leg coupled to the first frame and the second frame, wherein the support leg is configured to automatically deploy and prop the portable solar panel system upright when the first solar panel and the second solar panel are opened from a folded arrangement to an unfolded arrangement.

16. The portable solar panel system of claim 15, wherein the support leg has a first leg portion coupled to the first frame and a second leg portion coupled to the second frame, and wherein the first leg portion and the second leg portion are pivotably coupled and selectively separable.

17. The portable solar panel system of claim 16, wherein the support leg includes a foot having a first foot portion coupled to the first leg portion and a second foot portion coupled to the second leg portion, wherein the first foot portion defines an interface and includes a retainer, wherein the second foot portion defines a protrusion that is selectively received by the interface, and wherein the retainer is positioned to selectively engage with the protrusion to secure the protrusion within the interface.

18. A portable solar panel system comprising:
a first solar panel assembly;
a second solar panel assembly; and
a first hinge positioned to hingedly couple the first solar panel assembly to the second solar panel assembly to facilitate folding the first solar panel assembly and the second solar panel assembly;
wherein each of the first solar panel assembly and the second solar panel assembly includes:
a first solar panel;
a first frame extending around a first periphery of the first solar panel, the first frame including a first upper portion, a first lower portion, a first inner portion, and a first outer portion;
a second solar panel;
a second frame extending around a second periphery of the second solar panel, the second frame including a second upper portion, a second lower portion, a second inner portion, and a second outer portion;
a second hinge positioned along the first inner portion of the first frame and the second inner portion of the second frame to hingedly couple the first frame to the second frame, wherein the first hinge is positioned along the second outer portion of the second frame;
a handle coupled to the first outer portion of the first frame;
a first bracket coupled to the first upper portion of the first frame;
a second bracket coupled to the first inner portion of the first frame;
a third bracket coupled to the second upper portion of the second frame;
a fourth bracket coupled to the second inner portion of the second frame;
a first rod extending between the first bracket and the second bracket;
a second rod extending between the third bracket and the fourth bracket;
a first leg pivotably coupled to the first rod proximate the first bracket;
a second leg (a) pivotably coupled to the first rod proximate the second bracket and (b) coupled to the first leg at a first junction;
a third leg pivotably coupled to the second rod proximate the third bracket;
a fourth leg (a) pivotably coupled to the second rod proximate the fourth bracket and (b) coupled to the third leg at a second junction; and
a support foot pivotably and releasably coupling the first junction to the second junction, the support foot including a first foot portion coupled to the first junction and a second foot portion coupled to the second junction.

19. The portable solar panel system of claim 18, wherein one of the first foot portion or the second foot portion defines an interface and includes a retainer, wherein the other of the first foot portion or the second foot portion defines a protrusion that is selectively received by the interface, and wherein the retainer is positioned to selectively engage with the protrusion to secure the protrusion within the interface.

20. The portable solar panel system of claim 18, wherein the first leg and the second leg have a one-piece structure or a two-piece structure.
